(19) United States
(12) Patent Application Publication
(10) Pub. No.: US 2025/0001834 A1
(43) Pub. Date: Jan. 2, 2025

(54) METHOD FOR CONTROLLING A THERMAL CONDITIONING SYSTEM

(71) Applicant: VALEO SYSTEMES THERMIQUES, La Verriere (FR)

(72) Inventor: Rody EL CHAMMAS, La Verriere (FR)

(73) Assignee: VALEO SYSTEMES THERMIQUES, La Verriere (FR)

(21) Appl. No.: 18/710,426

(22) PCT Filed: Nov. 9, 2022
(86) PCT No.: PCT/EP2022/081292

§ 371 Date: May 15, 2024

(30) Foreign Application Priority Data
Nov. 15, 2021 (FR) FR2112024

(51) Int. Cl. B60H 1/32

(52) U.S. Cl. CPC B60H 1/3205

(57) ABSTRACT

The invention relates to a method for controlling a thermal conditioning system for a motor vehicle, including: a refrigerant circuit including in succession: a compressor, a two-fluid exchanger, a first expansion device positioned upstream of a first heat exchanger thermally coupled to an element of an electric drive train of the vehicle, a heat transfer liquid circuit including a second heat exchanger configured to exchange heat with an air stream inside a passenger compartment of the vehicle, the method including: i—determining an ambient temperature, ii—If the ambient temperature is less than a minimum temperature threshold: iii1—circulating refrigerant in succession in the compressor, in the two-fluid exchanger, and then in the first heat exchanger, iii2—circulating heat transfer liquid in the two-fluid exchanger, in the first heat exchanger, and in the second heat exchanger.

### TECHNICAL FIELD

The present invention relates to the field of thermal conditioning systems. Such thermal conditioning systems can in particular be provided on a motor vehicle. These systems allow thermal regulation of various members of the vehicle, such as the passenger compartment or an electrical energy storage battery, in the case of an electrically powered vehicle. The heat exchanges are mainly managed by the compression and expansion of a refrigerant within a plurality of heat exchangers.

### BACKGROUND OF THE INVENTION

Thermal conditioning systems often make use of a refrigerant loop and a loop for heat transfer fluid that exchanges heat with the refrigerant. Such systems are thus referred to as indirect. EP2933586 B1 is an example of such a system. The refrigerant loop makes it possible in particular to heat the passenger compartment of the vehicle by dissipating the heat originating from the condensing of the high-pressure refrigerant into an air stream sent to the passenger compartment. In this thermodynamic cycle, the vaporization of the low-pressure refrigerant is obtained by absorbing heat from an air stream outside the vehicle. This vaporization of the low-pressure refrigerant takes place in a heat exchanger generally situated on the front face of the vehicle. When the ambient temperature is negative, for example less than −10° C., it becomes difficult to achieve the vaporization of a sufficient flow of refrigerant to ensure sufficient heating power to ensure thermal comfort. It is thus common practice to use additional electric heating that is activated when the power extracted from the outside air stream becomes insufficient. The additional electric heating then supplies the missing thermal power. When the temperature becomes sufficient, the additional heating is deactivated.

The use of such additional heating has the drawback of increasing the cost of the thermal conditioning system, as well as its footprint and weight. There is therefore a need to provide a heating method that makes it possible to heat the passenger compartment of the vehicle without using an additional heating device.

### SUMMARY OF THE INVENTION

To this end, the present invention proposes a method for controlling a thermal conditioning system for a motor vehicle, the thermal conditioning system comprising:
A heat transfer liquid circuit configured to circulate a heat transfer liquid,
A refrigerant circuit comprising in succession:
a compression device,
a two-fluid exchanger,
a first expansion device positioned upstream of a first heat exchanger,
the two-fluid exchanger and the first heat exchanger being arranged both on the refrigerant circuit and on the heat transfer liquid circuit so as to allow a heat exchange between the refrigerant and the heat transfer liquid,
the heat transfer liquid circuit comprising a second heat exchanger configured to exchange heat with an air stream inside a passenger compartment of the vehicle, the control method comprising the following steps:
i—determining an ambient temperature outside the vehicle,
ii—if the ambient temperature is less than a first predetermined temperature threshold:
iii1—circulating refrigerant in succession in the compression device, in the two-fluid exchanger, and then in the first heat exchanger,
iii2-in conjunction with step iii1 of circulating refrigerant, circulating heat transfer liquid in the two-fluid exchanger, in the first heat exchanger, and in the second heat exchanger.

The compression device turns the refrigerant into high-pressure refrigerant. The high-pressure gaseous refrigerant condenses in the two-fluid exchanger. The condensation heat of the refrigerant is transferred to the heat transfer liquid circulating in the two-fluid exchanger. The refrigerant is then expanded in the first expansion device, and becomes low-pressure refrigerant. The low-pressure refrigerant evaporates in the first heat exchanger, and absorbs heat from the heat transfer liquid. As the compression device does work on the refrigerant, the amount of heat supplied to the heat transfer liquid in the two-fluid exchanger is greater than the amount of heat absorbed in the first heat exchanger. The heat transfer liquid is thus heated. This operating mode thus makes it possible to heat the heat transfer liquid with a view to heating the passenger compartment of the vehicle, without using additional heating, for example electric heating, and without the risk of icing up an evaporator situated on the front face when the ambient temperature is close to 0° C. The passenger compartment can thus be heated even at low temperatures, without using additional heating. The cost and footprint of the thermal conditioning system can thus be reduced.

The features listed in the following paragraphs can be implemented independently of one another or in any technically possible combination:

The first heat exchanger is configured to be thermally coupled to an element of an electric drive train of the vehicle.

The heat transfer liquid circuit is configured so that in at least one operating mode of the thermal conditioning system, the two-fluid exchanger, the second heat exchanger and the first heat exchanger are connected in series.

The element of the electric drive train of the vehicle is configured to exchange heat with the heat transfer liquid.

The first heat exchanger is configured to exchange heat with the heat transfer liquid.

In at least one operating mode, a portion of the heat transfer liquid circuit comprising the first heat exchanger communicates with a portion of the heat transfer liquid circuit comprising the drive train element.

Thermal coupling is thus produced between the first heat exchanger and the drive train element.

The heat transfer liquid circuit is configured so that in at least one operating mode of the thermal conditioning system, the two-fluid exchanger, the second heat exchanger, the first heat exchanger and the drive train element are connected in series.

According to one exemplary embodiment, the element of the electric drive train of the vehicle comprises an electric drive motor.

As a variant or in addition, the element of the electric drive train of the vehicle comprises an electronic module for controlling an electric drive motor of the vehicle.

As a variant or in addition, the element of the electric drive train of the vehicle comprises an electrical energy storage battery.

According to one embodiment of the control method, during step iii1 of circulating refrigerant, a mass flow rate of refrigerant in the two-fluid exchanger is equal to a mass flow rate of refrigerant in the first heat exchanger.

According to one exemplary embodiment, the control method comprises the following step:
iv-Determining a temperature of the heat transfer liquid at the inlet of the second heat exchanger.

The control method comprises the following step:
v1—If the temperature of the heat transfer liquid at the inlet of the second heat exchanger is less than or equal to a second predetermined temperature threshold, maintaining a flow rate of the inside air stream below a first predetermined flow rate threshold.

The first predetermined flow rate threshold is for example less than 50 kg/h.

As a variant or in addition, the control method can comprise the following step:
If the temperature of the heat transfer liquid at the outlet of the two-fluid exchanger is less than a predetermined minimum temperature, prohibiting the circulation of heat transfer liquid in the second heat exchanger.

The control method comprises the following step:
vi—If the temperature of the heat transfer liquid at the inlet of the second heat exchanger is less than or equal to the second predetermined temperature threshold, increasing a rotation speed of the compression device to a predetermined maximum value.

Increasing the rotation speed of the compression device makes it possible to increase the refrigerant flow rate in the circuit and thus the thermal power supplied.

The predetermined maximum value of the rotation speed of the compression device depends on a speed of travel of the vehicle.

When the vehicle is stopped, the noise emitted by the compression device is easier for the occupants of the vehicle to hear than when the vehicle is moving. The ambient noise is greater when the vehicle is moving.

The predetermined maximum value depends on a pressure of the refrigerant at the inlet of the compression device.

The control method can comprise the following step:
If the temperature of the heat transfer liquid at the inlet of the second heat exchanger is less than or equal to the second predetermined temperature threshold, reducing an effective flow area of the first expansion device so as to increase a compression rate of the refrigerant between an inlet and an outlet of the compression device.

By reducing the flow area of the first expansion device, the ratio of the pressures of the thermodynamic cycle increases. In other words, the ratio between the outlet pressure and the inlet pressures of the compression device increases. The thermal power supplied increases.

The control method comprises the following step:
v2—If the temperature of the heat transfer liquid at the inlet of the second heat exchanger is greater than the second predetermined temperature threshold, generating a flow rate of the inside air stream greater than a second predetermined flow rate threshold.

The second predetermined threshold is for example 100 kg/h.

When the temperature of the heat transfer liquid is sufficiently high, the air in contact with the second heat exchanger can be heated effectively. It is then possible to blow air onto the second exchanger so as to supply the passenger compartment of the vehicle with heated air.

The step of generating a flow rate of the inside air stream comprises a sub-step of activating a motor-fan unit configured to circulate an air stream.

The control method comprises the following step:
vii—If the temperature of the heat transfer liquid at the inlet of the second heat exchanger is greater than the second predetermined temperature threshold, controlling a rotation speed of the compression device so as to regulate a temperature of the heat transfer liquid at the inlet of the second heat exchanger at a setpoint value.

The rotation speed of the compression device can for example be controlled by a proportional-integral-derivative controller using the difference between the actual temperature of the heat transfer liquid at the inlet of the second heat exchanger and its setpoint value.

The control method comprises the following steps:
viii—Receiving a setpoint value of the temperature of the heat transfer liquid at the inlet of the second heat exchanger,
viii-1—Determining a temperature of the heat transfer liquid at the inlet of the second heat exchanger,
viii-2—Determining a difference between the temperature of the heat transfer liquid determined at the inlet of the second heat exchanger and the setpoint value of the temperature of the heat transfer liquid at the inlet of the second heat exchanger,
viii-3—If the difference determined is less than 0, increasing a rotation speed of the compression device.

The control method comprises the following step:
viii-4—If the difference determined is greater than 0 and less than a predetermined maximum value, reducing a rotation speed of the compression device.

The control method comprises the following step:
If the difference determined is greater than 0 and greater than the predetermined maximum value, deactivating the compression device.

The control method comprises the following step:
If the compression device is deactivated and the difference determined is greater than 0 and less than a predetermined minimum value, reactivating the compression device.

According to one exemplary embodiment of the control method, a temperature of the refrigerant at the inlet of the first heat exchanger is less than −15° C. during step i of circulating refrigerant in the first heat exchanger.

According to one exemplary embodiment of the control method, the flow rate of heat transfer liquid in the second heat exchanger is equal to the flow rate of heat transfer liquid in the two-fluid exchanger during step iii of circulating the heat transfer liquid heated in the second heat exchanger.

According to one variant embodiment of the control method, wherein the thermal conditioning system further comprises:
a second expansion device,
a third heat exchanger configured to exchange heat with an outside air stream, the third heat exchanger being configured to operate at least as an evaporator,
a refrigerant flow rate circulates in the third heat exchanger during step i of circulating refrigerant in the first heat exchanger.

The invention also relates to a thermal conditioning system for a motor vehicle, the thermal conditioning system comprising:
A heat transfer liquid circuit configured to circulate a heat transfer liquid,
A refrigerant circuit comprising in succession:
compression device,
a two-fluid exchanger,
a first expansion device positioned upstream of a first heat exchanger,
the two-fluid exchanger and the first heat exchanger being arranged both on the refrigerant circuit and on the heat transfer liquid circuit so as to allow a heat exchange between the refrigerant and the heat transfer liquid,
the heat transfer liquid circuit comprising a second heat exchanger configured to exchange heat with an air stream inside a passenger compartment of a motor vehicle,
An electronic control unit configured to implement the control method as described above.

The element of the electric drive train of the vehicle is configured to exchange heat with a heat transfer liquid circulating in an auxiliary heat transfer liquid loop. The heat exchanger is configured to exchange heat with the heat transfer liquid circulating in the auxiliary heat transfer liquid loop.

According to one exemplary embodiment, the thermal conditioning system further comprises:
a second expansion device,
a third heat exchanger configured to exchange heat with an outside air stream, the third heat exchanger being configured to operate at least as an evaporator.

The heat transfer liquid circuit comprises a main circulation loop, the main loop comprising the two-fluid exchanger and the second heat exchanger.

The auxiliary heat transfer liquid loop can be selectively connected to the main heat transfer liquid loop.

The main heat transfer liquid loop comprises a pump configured to circulate the heat transfer liquid.

The auxiliary heat transfer liquid loop comprises a pump, not shown, configured to circulate the heat transfer liquid.

The heat transfer liquid circuit comprises a first branch connecting a first connection point positioned on the main loop to a second connection point positioned on the auxiliary loop.

The heat transfer liquid circuit comprises a second branch connecting a third connection point positioned on the main loop to a fourth connection point positioned on the auxiliary loop.

The heat transfer liquid circuit comprises a third branch connecting a fifth connection point positioned on the main loop to a fifth heat exchanger.

The heat transfer liquid circuit comprises a fourth branch connecting the fifth heat exchanger to a sixth connection point positioned on the main loop.

According to a first embodiment, the thermal conditioning system comprises a refrigerant circuit comprising
a main loop comprising in succession in the direction of travel of the refrigerant:
a compression device,
a two-fluid exchanger,
a first expansion device,
a first heat exchanger,
the two-fluid exchanger and the first heat exchanger being arranged both on the refrigerant circuit and on the heat transfer liquid circuit so as to allow a heat exchange between the refrigerant and the heat transfer liquid,
the first heat exchanger being configured to be thermally coupled to an element of an electric drive train of the vehicle,
a first bypass branch connecting a first junction point positioned on the main loop downstream of the two-fluid exchanger and upstream of the first expansion device to a second junction point positioned on the main loop downstream of the first heat exchanger and upstream of the compression device, the first bypass branch comprising a second expansion device and a third heat exchanger configured to exchange heat with an outside air stream, the third heat exchanger being configured to operate at least as an evaporator,
a second bypass branch connecting a third junction point positioned on the main loop downstream of the first junction point and upstream of the first expansion device to a fourth junction point positioned on the main loop downstream of the first heat exchanger and upstream of the second junction point, the second bypass branch comprising a third expansion device and a fourth heat exchanger configured to exchange heat with the inside air stream.

The heat transfer liquid circuit comprises a fifth heat exchanger configured to exchange heat with the outside air stream.

The fifth heat exchanger is positioned upstream of the third heat exchanger in a direction of flow of the outside air stream.

According to one variant embodiment, the main loop comprises a first internal exchanger configured to allow a heat exchange between the high-pressure refrigerant downstream of the two-fluid exchanger and upstream of the first junction point, and the low-pressure refrigerant downstream of the second junction point and upstream of the compression device.

According to one variant embodiment, the main loop comprises a second internal exchanger configured to allow a heat exchange between the high-pressure refrigerant downstream of the first junction point and upstream of the third junction point, and the low-pressure refrigerant downstream of the fourth junction point and upstream of the second junction point.

The first internal exchanger and the second internal exchanger make it possible to increase the heat exchanges and thus improve the performance of the thermal conditioning system.

According to a second embodiment, the thermal conditioning system comprises a refrigerant circuit comprising
a main loop comprising in succession in the direction of travel of the refrigerant:
a compression device,
a two-fluid exchanger,
a first expansion device,
a first heat exchanger,
the two-fluid exchanger and the first heat exchanger being arranged both on the refrigerant circuit and on the heat transfer liquid circuit so as to allow a heat exchange between the refrigerant and the heat transfer liquid,
the first heat exchanger being configured to be thermally coupled to an element of an electric drive train of a motor vehicle,
a second bypass branch connecting a third junction point positioned on the main loop downstream of the two-fluid exchanger and upstream of the first expansion device to a fourth junction point positioned on the main loop downstream of the first heat exchanger and upstream of the compression device, the first bypass branch comprising a third expansion device and a fourth heat exchanger configured to exchange heat with the inside air stream,
a first bypass branch connecting a first junction point positioned on the second bypass branch downstream of the fourth heat exchanger and upstream of the fourth junction point to a second junction point positioned on the main loop downstream of the fourth junction point and upstream of the compression device, the first bypass branch comprising a second expansion device and a third heat exchanger configured to exchange heat with an outside air stream, the third heat exchanger being configured to operate at least as an evaporator.

According to one variant embodiment, the refrigerant circuit comprises a second internal heat exchanger configured to allow a heat exchange between the high-pressure refrigerant circulating in the main loop downstream of the first internal exchanger and upstream of the third junction point, and the low-pressure refrigerant in the main loop downstream of the fourth junction point and upstream of the second junction point.

According to one aspect of the thermal conditioning system, the main loop comprises a refrigerant accumulation device positioned downstream of the two-fluid exchanger and upstream of the third junction point.

According to one embodiment of the thermal conditioning system, the main loop comprises a refrigerant accumulation device positioned downstream of the two-fluid exchanger and upstream of the first junction point.

According to embodiment of the thermal conditioning system, the main loop comprises a refrigerant accumulation device positioned downstream of the two-fluid exchanger and upstream of the first internal exchanger.

### BRIEF DESCRIPTION OF THE DRAWINGS

Further features, details and advantages will become apparent on reading the detailed description below, and on studying the appended drawings, in which:

FIG. 1 is a schematic view of a thermal conditioning system according to a first embodiment of the invention, in which the control method according to the invention is implemented,

FIG. 2 is a schematic view of a thermal conditioning system according to a variant of the first embodiment of the invention,

FIG. 3 is a schematic view of a thermal conditioning system according to a second embodiment of the invention,

FIG. 4 is a schematic view of a thermal conditioning system according to a variant of the second embodiment of the invention,

FIG. 5 is a schematic view of a thermal conditioning system according to the first embodiment of the invention, when the method according to the invention is implemented,

FIG. 6 is a schematic side view of a vehicle provided with a thermal conditioning system according to FIGS. 1 to 5,

FIG. 7 is a first part of a block diagram illustrating various steps of the method according to the invention,

FIG. 8 is a curve showing the change over time of several parameters of the method according to the invention,

FIG. 9 is a curve showing the change over time of several other parameters of the method, and

FIG. 10 is a second part of the block diagram illustrating various steps of the method according to the invention.

### DETAILED DESCRIPTION OF THE INVENTION

In order to make the figures easier to read, the different elements are not necessarily shown to scale. In these figures, identical elements have the same reference signs. Some elements or parameters can be given ordinal numbers, in other words designated for example first element or second element, or first parameter and second parameter, etc. The purpose of this ordinal numbering is to make a distinction between elements or parameters that are similar but not identical. This ordinal numbering does not imply any priority of one element, or parameter, over another and the designations can be interchanged.

In the description below, the expression “a first element upstream of a second element” means that the first element is placed before the second element with respect to the direction of circulation, or travel, of a fluid. Similarly, the expression “a first element downstream of a second element” means that the first element is placed after the second element with respect to the direction of circulation, or travel, of the fluid concerned. In the case of the refrigerant circuit, the expression “a first element is upstream of a second element” means that the refrigerant travels in succession through the first element and then the second element, without passing through the compression device. In other words, the refrigerant leaves the compression device, passes through one or more elements and then passes through the first element, then the second element, then returns to the compression device, optionally having passed through further elements.

The expression “a second element is placed between a first element and a third element” means that the shortest path for travelling from the first element to the third element passes through the second element.

When it is specified that a sub-system comprises a given element, this does not rule out the presence of other elements in this sub-system.

In the thermal conditioning system 100 described, an electronic control unit 50 receives information from various sensors, not shown, measuring in particular the characteristics of the refrigerant at various points on the circuit. The electronic control unit 50 also receives setpoints issued by the occupants of the vehicle, such as the desired temperature inside the passenger compartment for example. The electronic control unit implements control laws for operating different actuators, in order to control the thermal conditioning system 100 so as to achieve the setpoints received. The electronic control unit 50 particularly implements the method according to the invention.

Each of the expansion devices used can be an electronic expansion valve, a thermostatic expansion device, or a calibrated orifice. In the case of an electronic expansion valve, the flow area allowing the refrigerant to pass through can be adjusted continuously between a closed position and a fully open position. To this end, the control unit of the system controls an electric motor that moves a movable shut-off device controlling the flow area available to the refrigerant.

The compression device 3 can be an electric compressor, that is a compressor with moving parts driven by an electric motor. The compression device 3 comprises a suction side for the low-pressure refrigerant, also referred to as the inlet 3a of the compression device, and a discharge side for the high-pressure refrigerant, also referred to as the outlet 3b of the compression device 3. The internal moving parts of the compressor 3 take the refrigerant from low pressure on the inlet 3a side to high pressure on the outlet 3b side. The work of compression and discharge is done by means of the energy supplied by the electric motor. After expansion in one or more expansion devices, the refrigerant returns to the inlet 3a of the compressor 3 and begins a new thermodynamic cycle.

The refrigerant circuit 2 forms a closed circuit in which the refrigerant can circulate. The refrigerant circuit 2 is sealed when it is in a nominal operating state, that is, without defects or leaks. Each junction point of the circuit 2 allows the refrigerant to enter one or other of the circuit portions that meet at this junction point. The refrigerant is distributed between the circuit portions meeting at a junction point by adjusting the opening or closure of the stop valves, non-return valves or expansion device included on each of the branches. In other words, each junction point is a means for redirecting the refrigerant arriving at this junction point. These stop valves and non-return valves thus make it possible to selectively direct the refrigerant into the various branches of the refrigerant circuit so as to achieve different operating modes, as will be described below.

The refrigerant used by the refrigerant circuit 2 is in this case a chemical fluid such as R1234yf. Other refrigerants can also be used, such as R134a or R744 for example.

Inside air stream Fi is given to mean an air stream intended for the passenger compartment of the motor vehicle. This inside air stream can circulate in an HVAC (Heating, Ventilating and Air Conditioning) installation. This installation is not shown in the various figures.

Outside air stream Fe is given to mean an air stream not intended for the passenger compartment of the vehicle. In other words, this air stream Fe remains outside the passenger compartment of the vehicle. A motor-fan unit 35 can be activated in order to increase the flow rate of the outside air stream Fe if necessary. The air flow rate provided by the motor-fan unit 35 can be adjusted for example by the electronic control unit 50 of the thermal conditioning system 100.

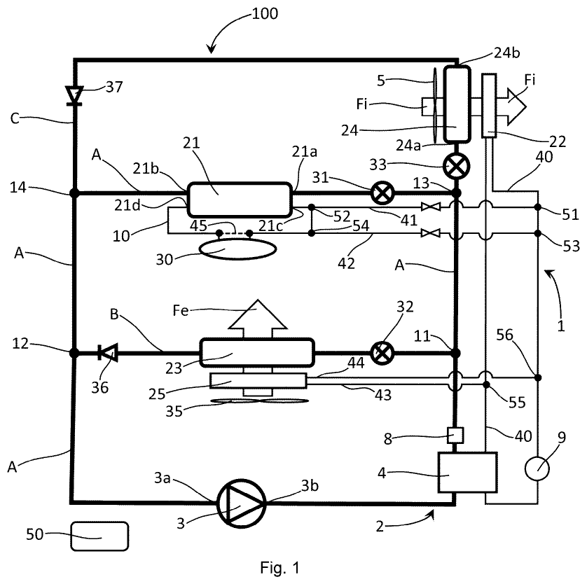

FIG. 1 shows a thermal conditioning system 100 for a motor vehicle, the thermal conditioning system 100 comprising:
A heat transfer liquid circuit 1 configured to circulate a heat transfer liquid,
A refrigerant circuit 2 comprising in succession:
a compression device 3,
a two-fluid exchanger 4,
a first expansion device 31 positioned upstream of a first heat exchanger 21,
the two-fluid exchanger 4 and the first heat exchanger 21 being arranged both on the refrigerant circuit 2 and on the heat transfer liquid circuit 1 so as to allow a heat exchange between the refrigerant and the heat transfer liquid,
the heat transfer liquid circuit 1 comprising a second heat exchanger 22 configured to exchange heat with an air stream Fi inside a passenger compartment of the motor vehicle,
An electronic control unit 50 configured to implement the control method according to the invention.

The first heat exchanger 21 is arranged both on the refrigerant circuit 2 and on the heat transfer liquid circuit 1 so as to allow a heat exchange between the refrigerant and the heat transfer liquid. The first heat exchanger 21 comprises an inlet 21a and an outlet 21b for refrigerant, and an inlet 21c and an outlet 21d for heat transfer liquid. The refrigerant and the heat transfer liquid can exchange heat as they pass through the first heat exchanger 21. In other words, the first heat exchanger 21 is a second two-fluid exchanger. The first heat exchanger 21 is for example a plate exchanger. The heat transfer liquid is for example a mixture of water and glycol, with a solidification temperature of less than −30° C.

The first heat exchanger 21 is configured to be thermally coupled to an element 30 of an electric drive train of a motor vehicle. The element 30 of the electric drive train of the vehicle is configured to exchange heat with a heat transfer liquid circulating in an auxiliary heat transfer liquid loop 10. The first heat exchanger 21 is configured to exchange heat with the heat transfer liquid circulating in the auxiliary heat transfer liquid loop 10. The heat transfer liquid thus provides thermal coupling between the first heat exchanger 21 and the element 30. When the drive train element 30 dissipates heat, due to its operation, this can be at least partially recovered.

The element 30 of the electric drive train of the vehicle comprises for example an electric drive motor of the vehicle. As a variant or in addition, the element 30 of the electric drive train of the vehicle comprises an electronic module for controlling an electric drive motor of the vehicle. As a variant or in addition, the element 30 of the electric drive train of the vehicle can also comprise an electrical energy storage battery.

The element 30 of the electric drive train of the vehicle is configured to exchange heat with the heat transfer liquid. To this end, the heat transfer liquid can circulate in a casing of the element 30 of the electric drive train, comprising a heat transfer liquid inlet and outlet. The casing forms a heat transfer liquid circulation duct between the inlet and the outlet. Heat can thus be exchanged between the element 30 and the heat transfer liquid.

The first heat exchanger 21 is configured to exchange heat with the heat transfer liquid. To this end, in at least one operating mode of the thermal conditioning system 100, a portion of the heat transfer liquid circuit 1 comprising the first heat exchanger 21 communicates with a portion of the heat transfer liquid circuit 1 comprising the drive train element 30. Thermal coupling is thus produced between the first heat exchanger 21 and the drive train element 30.

In the example illustrated in FIGS. 1 to 5, the thermal conditioning system 100 further comprises:
a second expansion device 32,
a third heat exchanger 23 configured to exchange heat with an outside air stream Fe, the third heat exchanger 23 being configured to operate at least as an evaporator.

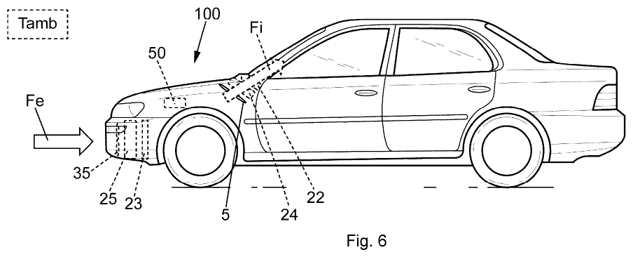

The second expansion device 32 is positioned upstream of the third heat exchanger 23. The second expansion device 32 makes it possible to adjust the pressure of the refrigerant at the inlet of the third heat exchanger 23. FIG. 6 schematically shows the location in the vehicle of the heat exchangers interacting with the outside air stream Fe or the inside air stream Fi.

The thermal conditioning system 100 comprises a third heat exchanger 23 allowing the thermal conditioning system 100 to operate in a so-called heat pump operating mode. In this operating mode, the heat necessary to evaporate the refrigerant is drawn from an outside air stream Fe. The heat pump mode can in particular be used when the ambient temperature is sufficiently high so that there is no risk of the water vapor contained in the outside air stream Fe freezing.

When the ambient temperature is close to 0° C., the heat pump mode can become unusable. The refrigerant evaporates at a lower temperature than the temperature of the outside air stream, which is substantially equal to the ambient temperature. Evaporation thus takes place at a negative temperature. The water vapor contained in the ambient air can thus turn to ice and build up on the surface of the third heat exchanger 23. The build-up of ice is detrimental to thermal exchange, which means that the thermodynamic performance drops, until this operating mode is prevented. In order to heat the passenger compartment even in a cold environment, it is usual practice to incorporate an additional electric heating device in the thermal conditioning system. This additional component significantly increases the cost price of the system, and increases its weight and footprint. It is therefore desirable to be able to provide heating of the passenger compartment even in a cold environment without adding an additional heating device.

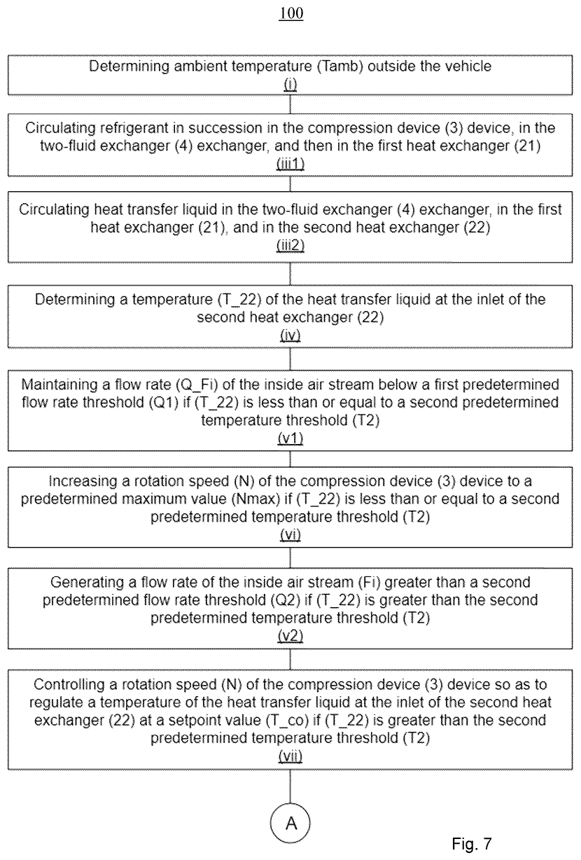

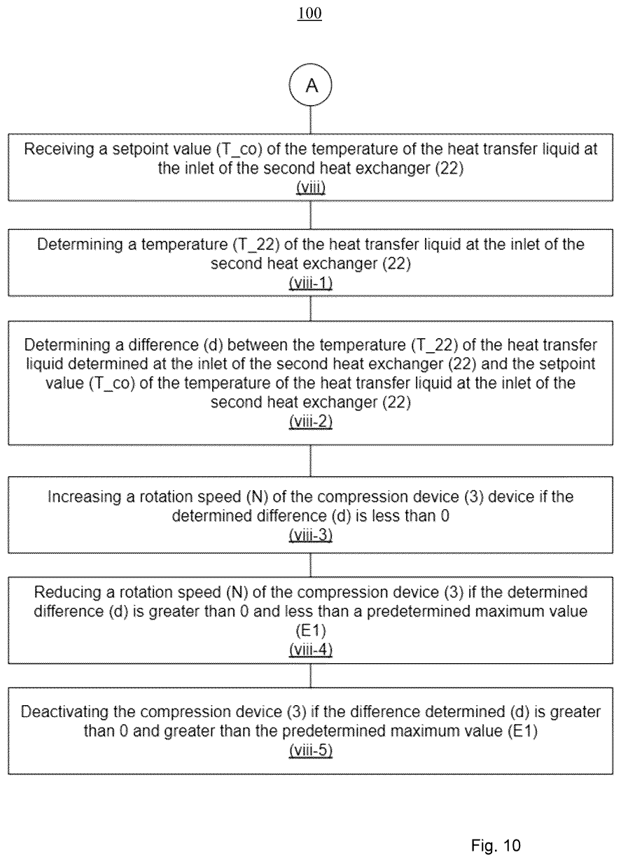

To this end as shown in FIGS. 7 and 10, the present invention proposes a method for controlling a thermal conditioning system 100 for a motor vehicle, the thermal conditioning system 100 comprising:
A heat transfer liquid circuit 1 configured to circulate a heat transfer liquid,
A refrigerant circuit 2 comprising in succession:
a compression device 3,
a two-fluid exchanger 4,
a first expansion device 31 positioned upstream of a first heat exchanger 21,
the two-fluid exchanger 4 and the first heat exchanger 21 being arranged both on the refrigerant circuit 2 and on the heat transfer liquid circuit 1 so as to allow a heat exchange between the refrigerant and the heat transfer liquid,
the heat transfer liquid circuit 1 comprising a second heat exchanger 22 configured to exchange heat with an air stream Fi inside a passenger compartment of the vehicle, the control method comprising the following steps:
i—determining an ambient temperature Tamb outside the vehicle,
ii—if the ambient temperature Tamb is less than a first predetermined temperature threshold T1:
iii1—circulating refrigerant in succession in the compression device 3, in the two-fluid exchanger 4, and then in the first heat exchanger 21,
iii2—in conjunction with step iii1 of circulating refrigerant, circulating heat transfer liquid in the two-fluid exchanger 4, in the first heat exchanger 21, and in the second heat exchanger 22.

The compression device 3 turns the refrigerant into high-pressure refrigerant. The high-pressure gaseous refrigerant condenses in the two-fluid exchanger 4. The condensation heat of the refrigerant is transferred to the heat transfer liquid circulating in the two-fluid exchanger 4. The refrigerant thus heats the heat transfer liquid in the two-fluid exchanger 4. The refrigerant is then expanded in the first expansion device 31, and becomes low-pressure refrigerant. The low-pressure refrigerant evaporates in the first heat exchanger 21, and absorbs heat from the heat transfer liquid. As the compression device 3 does work on the refrigerant, the amount of heat supplied to the heat transfer liquid in the two-fluid exchanger 4 is greater than the amount of heat absorbed in the first heat exchanger 21. The heat transfer liquid is thus heated overall. This operating mode thus makes it possible to heat the heat transfer liquid with a view to heating the passenger compartment of the vehicle, without using additional heating, for example electric heating, and without the risk of icing up an evaporator situated on the front face when the ambient temperature is close to 0° C. The passenger compartment can thus be heated even at low temperatures, without using additional heating. The cost and footprint of the thermal conditioning system can thus be reduced compared to a conventional thermal conditioning system. In the example illustrated, the first heat exchanger 21 is configured to be thermally coupled to an element 30 of an electric drive train of the vehicle. It is thus possible to at least partially recover the heat dissipated during the operation of the element 30 of the drive train.

The ambient temperature is the temperature of the air in the vicinity of the vehicle and outside the vehicle. Preferably, the ambient temperature is measured in a location in the vehicle where the air temperature is not affected by the operation of the vehicle.

The refrigerant circulating in the two-fluid exchanger 4 is high-pressure refrigerant. The refrigerant circulating in the first heat exchanger 21 is low-pressure refrigerant. The high-pressure refrigerant at the outlet of the two-fluid exchanger 4 is expanded in the first expansion device 31 and becomes low-pressure refrigerant, and then circulates in the first heat exchanger 21.

The heat transfer liquid circuit 1 is configured so that in at least a first operating mode of the thermal conditioning system 100, the two-fluid exchanger 4, the second heat exchanger 22 and the first heat exchanger 21 are connected in series. In the example shown, the heat transfer liquid can thus circulate in succession in the two-fluid exchanger 4, in the first heat exchanger 21, and in the second heat exchanger 22. According to one variant, not shown, the heat transfer liquid can circulate in succession in the two-fluid exchanger 4, in the second heat exchanger 22, and then in the first heat exchanger 21. In both cases, the heat transfer liquid circulates in a closed loop in the two-fluid exchanger 4, the first heat exchanger 21, and the second heat exchanger 22.

The heat transfer liquid circuit 1 is configured so that in at least a second operating mode of the thermal conditioning system 100, the two-fluid exchanger 4, the second heat exchanger 22, the first heat exchanger 21 and the drive train element 30 are connected in series.

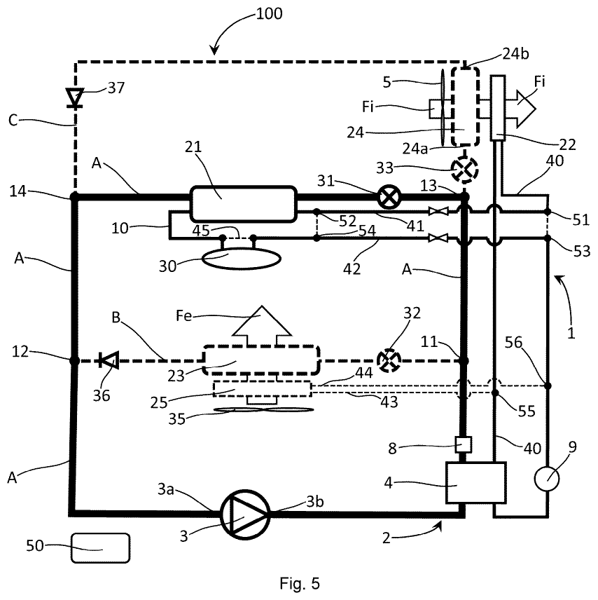

FIG. 5 schematically shows the circulation of the refrigerant and the circulation of the heat transfer liquid when the method according to the invention is applied. In this figure, the portions of the refrigerant circuit 2 in which refrigerant circulates are shown in bold lines. The portions of the circuit 2 in which the refrigerant does not circulate are shown in dashed lines. Likewise, the portions of the heat transfer liquid circuit 1 in which heat transfer liquid circulates are shown in bold lines and the portions of the circuit 1 in which the heat transfer liquid does not circulate are shown in dashed lines. The refrigerant circulates in succession in the compression device 3, in the two-fluid exchanger 4 and in the first heat exchanger 21, and then returns to the compression device 3. The heat transfer liquid circulates in succession in the two-fluid exchanger 4, in the second heat exchanger 22, in the first heat exchanger 1 and in the drive train element 30, and returns to the two-fluid exchanger 4.

According to one embodiment of the control method, during step iii1 of circulating refrigerant, a mass flow rate of refrigerant in the two-fluid exchanger 4 is equal to a mass flow rate of refrigerant in the first heat exchanger 21. In other words, all of the refrigerant flow rate leaving the two-fluid exchanger 4 reaches and passes through the first heat exchanger 21. The other branches of the refrigerant circuit 2, and the heat exchangers positioned thereon, are not passed through by a refrigerant flow rate.

The control method comprises the following step:
iv—Determining a temperature T_22 of the heat transfer liquid at the inlet of the second heat exchanger 22.
v1—If the temperature T_22 of the heat transfer liquid at the inlet of the second heat exchanger 22 is less than or equal to a second predetermined temperature threshold T2, maintaining a flow rate Q_Fi of the inside air stream below a first predetermined flow rate threshold Q1.

The first predetermined flow rate threshold Q1 is for example less than 50 kg/h. The flow rate Q_Fi of the inside air Fi is thus maintained at a very low value so that the heat exchange in the second heat exchanger 22 is negligible. During this operating phase, the temperature of the heat transfer liquid is too low to effectively heat the inside air stream Fi, and it is not desirable to blow fresh air onto the occupants of the vehicle due to the discomfort caused by such blown fresh air.

A motor-fan unit 5 makes it possible to generate an air stream Fi on the second heat exchanger 22. The motor-fan unit 5 is for example positioned upstream of the second heat exchanger 22. In order to limit the flow rate of the air Fi on the second heat exchanger 22 to a low value, the motor-fan unit is kept inactive, that is, not commanded. In addition, a movable shutter can be controlled so as to prevent the circulation of air on the second heat exchanger 22. The shutter is not shown in the figures.

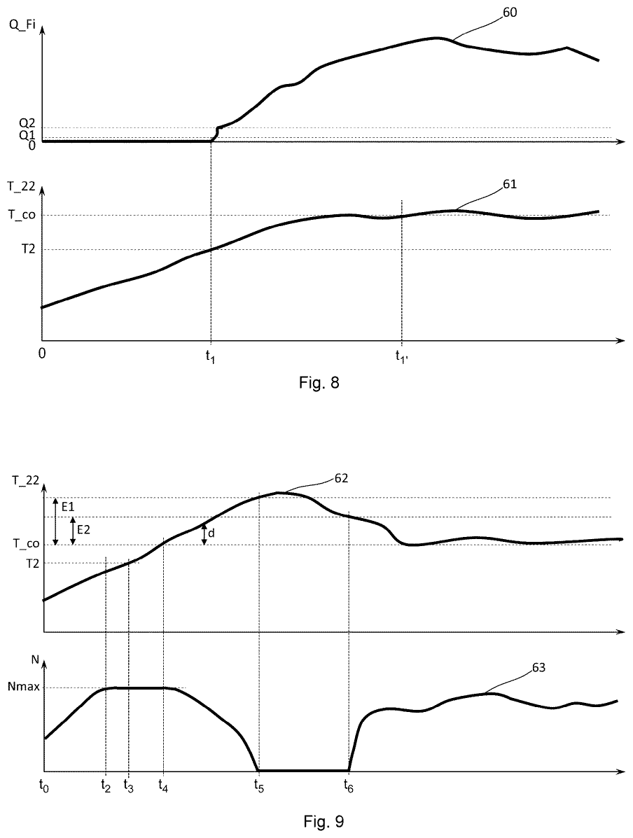

In FIG. 8, the curve 60 schematically shows the change in the flow rate Q_Fi of the inside air stream Fi as a function of time. The curve 61 schematically shows the change in the temperature T_22 of the heat transfer liquid at the inlet of the second heat exchanger 22. From the initial time to time t1, the air flow rate Q_Fi is maintained at a value of less than Q1 as the temperature T_22 is less than the threshold T2.

According to one variant, not shown, the control method can comprise the following step:
If the temperature of the heat transfer liquid at the outlet of the two-fluid exchanger 4 is less than a predetermined minimum temperature, prohibiting the circulation of heat transfer liquid in the second heat exchanger 22.

The control method comprises the following step:
vi—If the temperature T_22 of the heat transfer liquid at the inlet of the second heat exchanger 22 is less than or equal to the second predetermined temperature threshold T2, increasing a rotation speed N of the compression device 3 to a predetermined maximum value Nmax.

Increasing the rotation speed of the compression device 3 makes it possible to increase the refrigerant flow rate in the circuit 2 and thus the thermal power supplied.

In FIG. 9, the curve 63 schematically shows the change in the rotation speed of the compression device 3 as a function of time. The curve 62 schematically shows the change in the temperature T_22 of the heat transfer liquid at the inlet of the second heat exchanger 22. In this example, the maximum speed Nmax of the compressor 3 is reached at time t2.

The predetermined maximum value Nmax of the rotation speed of the compression device 3 depends on a speed of travel of the vehicle. When the vehicle is stopped, the noise emitted by the compression device is easier for the occupants of the vehicle to hear than when the vehicle is moving. The ambient noise is greater when the vehicle is moving. The noise generated by the operation of the compression device increases when the rotation speed increases. A higher rotation speed can be accepted when the background noise is greater.

The predetermined maximum value Nmax depends on a pressure of the refrigerant at the inlet of the compression device 3. Increasing the rotation speed of the compression device 3 causes the pressure at the inlet thereof to drop. In order not to risk taking air into the circuit, the inlet pressure is maintained at a value greater than the value of the ambient atmospheric pressure. The minimum permissible value of the pressure at the inlet of the compressor 3 is for example 1.2 bar. When the minimum pressure threshold is reached, the rotation speed of the compressor is maintained at its current value and does not increase further.

The control method can comprise the following step:
If the temperature T_22 of the heat transfer liquid at the inlet of the second heat exchanger 22 is less than or equal to the second predetermined temperature threshold, reducing an effective flow area of the first expansion device 31 so as to increase a compression rate of the refrigerant between an inlet 3a and an outlet 3b of the compression device 3.

Decreasing the flow area of the first expansion device 31, so as to expand the refrigerant more, increases the ratio between the outlet pressure and the inlet pressure of the compression device 3. The thermal power supplied by the thermal conditioning system increases.

The control method comprises the following step:
v2—If the temperature T_22 of the heat transfer liquid at the inlet of the second heat exchanger 22 is greater than the second predetermined temperature threshold T2, generating a flow rate of the inside air stream Fi greater than a second predetermined flow rate threshold Q2.

This step is illustrated in FIG. 8, after the time t1 when the temperature T_22 becomes greater than the second threshold T2. The second predetermined threshold Q2 is for example 100 kg/h. As the temperature of the heat transfer liquid is then sufficiently high, the air in contact with the second heat exchanger 22 can be heated effectively. It is then possible to blow air onto the second exchanger 22 so as to supply the passenger compartment of the vehicle with heated air.

The step of generating a flow rate of the inside air stream Fi comprises a sub-step of activating a motor-fan unit 5 configured to circulate an air stream.

The control method comprises the following step:
vii—If the temperature T_22 of the heat transfer liquid at the inlet of the second heat exchanger 22 is greater than the second predetermined temperature threshold T2, controlling a rotation speed N of the compression device 3 so as to regulate a temperature T_22 of the heat transfer liquid at the inlet of the second heat exchanger 22 at a setpoint value T_co.

The rotation speed of the compression device 3 can for example be controlled by a proportional-integral-derivative controller using as an input variable the difference between the actual temperature of the heat transfer liquid at the inlet of the second heat exchanger 22 and its setpoint value T_co. The control method is schematically illustrated in FIG. 9.

The control method comprises the following steps:
viii—Receiving a setpoint value T_co of the temperature of the heat transfer liquid at the inlet of the second heat exchanger 22,
viii-1—Determining a temperature T_22 of the heat transfer liquid at the inlet of the second heat exchanger 22,
viii-2—Determining a difference d between the temperature T_22 of the heat transfer liquid determined at the inlet of the second heat exchanger 22 and the setpoint value T_co of the temperature of the heat transfer liquid at the inlet of the second heat exchanger 22,
viii-3—If the difference determined d is less than 0, increasing a rotation speed N of the compression device 3.

These steps correspond to the time interval from t0 to t4.

The control method comprises the following step:
viii-4—If the difference determined d is greater than 0 and less than a predetermined maximum value E1, reducing a rotation speed N of the compression device 3.

If the actual temperature of the heat transfer liquid is greater than the setpoint value while being sufficiently close, the rotation speed of the compressor 3 is reduced in order to limit the heat gain of the heat transfer liquid, and thus make it possible to reach the temperature setpoint value T_co. This step can be seen in FIG. 9 in the time interval between t4 and t5.

The control method comprises the following step:
If the difference determined d is greater than 0 and greater than the predetermined maximum value E1, deactivating the compression device 3.

If the actual temperature of the heat transfer liquid is greater than the setpoint value and is too far away from it, the compression device ceases to be commanded. The heat gain of the heat transfer liquid is thus stopped, which allows the temperature of the heat transfer liquid to return to the setpoint more quickly. This step can be seen in FIG. 9 in the time interval between t5 and t6.

The control method comprises the following step:
If the compression device is deactivated and the difference determined d is greater than 0 and less than a predetermined minimum value E2, reactivating the compression device 3.

Once the compression device ceases to be commanded, the temperature of the heat transfer liquid decreases. When the temperature becomes sufficiently close to the setpoint value, the operation of the compression device is reactivated. The regulation of the rotation speed, as described above, resumes. This step can be seen in FIG. 9 in the time interval starting after the time t6.

According to one exemplary embodiment of the control method, a temperature of the refrigerant at the inlet of the first heat exchanger 21 is less than −15° C. during step i of circulating refrigerant in the first heat exchanger 21. This value allows effective thermal transfer in the first heat exchanger 21, and therefore effective energy recovery. A temperature value considerably less than 0° C. can be selected, as there is no risk of the heat transfer liquid in contact with the first heat exchanger 21 freezing.

According to one exemplary embodiment of the control method, the flow rate of heat transfer liquid in the second heat exchanger 22 is equal to the flow rate of heat transfer liquid in the two-fluid exchanger 4 during step iii of circulating the heat transfer liquid heated in the second heat exchanger 22.

According to one variant embodiment of the control method, wherein the thermal conditioning system 100 comprises:
a second expansion device 32,
a third heat exchanger 23 configured to exchange heat with an outside air stream Fe, the third heat exchanger 23 being configured to operate at least as an evaporator.
a refrigerant flow rate circulates in the third heat exchanger 23 during step i of circulating refrigerant in the first heat exchanger 21.

In other words, in this operating phase, the third heat exchanger 23 also takes part in the thermal exchanges of the thermal conditioning system and contributes to supplying the heat that heats the passenger compartment of the vehicle. This operating phase can be applied when there is no risk that the outside temperature will cause the third heat exchanger to ice up. This operating phase can also be applied temporarily, even when there is a risk of the third exchanger icing up. In this case, the application period of this operating phase is sufficiently short so that the build-up of ice does not have time to occur.

The heat transfer liquid circuit 1 will now be described in greater detail. The heat transfer liquid circuit 1 comprises a main circulation loop 40, the main loop 40 comprising the two-fluid exchanger 4 and the second heat exchanger 22.

The auxiliary heat transfer liquid loop 10 can be selectively connected to the main heat transfer liquid loop 40. In other words, according to some operating modes, the auxiliary loop 10 and the main loop 40 are connected. Under these conditions, the heat transfer liquid of the auxiliary loop 10 mixes with the heat transfer liquid of the main heat transfer liquid loop 40.

The main heat transfer liquid loop 40 comprises a pump 9 configured to circulate the heat transfer liquid. The auxiliary heat transfer liquid loop 10 also comprises a pump, not shown, configured to circulate the heat transfer liquid.

The heat transfer liquid circuit 1 comprises a first branch 41 connecting a first connection point 51 positioned on the main loop 40 to a second connection point 52 positioned on the auxiliary loop 10. The heat transfer liquid circuit 1 comprises a second branch 42 connecting a third connection point 53 positioned on the main loop 40 to a fourth connection point 54 positioned on the auxiliary loop 10.

The first branch 41 and the second branch 42 make it possible to connect the main heat transfer liquid loop 40 and the auxiliary heat transfer liquid loop 10.

The heat transfer liquid circuit 1 comprises a third branch 43 connecting a fifth connection point 55 positioned on the main loop 40 to a fifth heat exchanger 25. The heat transfer liquid circuit 1 comprises a fourth branch 44 connecting the fifth heat exchanger 25 to a sixth connection point 56 positioned on the main loop 40. The fifth heat exchanger 25 is configured to exchange heat with the outside air stream Fe. The third branch 43 and the fourth branch 44 make it possible to connect the main heat transfer liquid loop 40 and the fifth heat exchanger 25. In some operating modes, the heat transfer liquid can thus be cooled by the outside air stream Fe by circulating in the fifth heat exchanger.

The heat transfer liquid circuit 1 also comprises a fifth branch 45 that connects the inlet and the outlet of the element 30. In other words, the fifth branch 45 is a bypass branch allowing the heat transfer liquid coming from the outlet 21d of the first heat exchanger to reach the fourth connection point 54 without passing through the element 30, therefore without exchanging heat with the element 30. It is thus possible to apply the control method described by circulating heat transfer liquid in the two-fluid exchanger 4, the second heat exchanger 22 and the first heat exchanger 21, without passing through the element 30 of the drive train of the vehicle.

FIG. 1 depicts a first embodiment of the thermal conditioning system 100. The thermal conditioning system 100 comprises a refrigerant circuit 2 comprising
a main loop A comprising in succession, in the direction of travel of the refrigerant:
a compression device 3,
a two-fluid exchanger 4,
a first expansion device 31,
a first heat exchanger 21,
the two-fluid exchanger 4 and the first heat exchanger 21 being arranged both on the refrigerant circuit 2 and on the heat transfer liquid circuit 1 so as to allow a heat exchange between the refrigerant and the heat transfer liquid,
the first heat exchanger 21 being configured to be thermally coupled to an element 30 of an electric drive train of the vehicle,
a first bypass branch B connecting a first junction point 11 positioned on the main loop A downstream of the two-fluid exchanger 4 and upstream of the first expansion device 31 to a second junction point 12 positioned on the main loop A downstream of the first heat exchanger 21 and upstream of the compression device 3, the first bypass branch B comprising a second expansion device 32 and a third heat exchanger 23 configured to exchange heat with an outside air stream Fe, the third heat exchanger 23 being configured to operate at least as an evaporator,
a second bypass branch C connecting a third junction point 13 positioned on the main loop A downstream of the first junction point 11 and upstream of the first expansion device 31 to a fourth junction point 14 positioned on the main loop A downstream of the first heat exchanger 21 and upstream of the second junction point 12, the second bypass branch C comprising a third expansion device 33 and a fourth heat exchanger 24 configured to exchange heat with the inside air stream Fi.

The first bypass branch B is positioned in parallel with a portion of the main loop A comprising the first expansion device 31 and the first heat exchanger 21. The second bypass branch C is positioned in parallel with a portion of the main loop A comprising the first expansion device 31 and the first heat exchanger 21.

The heat transfer liquid circuit 1 comprises a fifth heat exchanger 25 configured to exchange heat with the outside air stream Fe. The fifth heat exchanger 25 is positioned upstream of the third heat exchanger 23 in a direction of flow of the outside air stream Fe.

The first bypass branch B comprises a non-return valve 36 configured to prevent the circulation of the refrigerant from the second junction point 12 to the first junction point 11. The second bypass branch C comprises a non-return valve 37 configured to prevent the circulation of the refrigerant from the fourth junction point 14 to the third junction point 13. The non-return valve 36 prevents the migration of the refrigerant towards the third exchanger 23 when it is not contributing to the heat exchanges, that is, when the second expansion device 32 is in the closed position. Likewise, the non-return valve 37 prevents the migration of the refrigerant towards the fourth heat exchanger 24 when the third expansion device 33 is in the closed position and the fourth exchanger 24 is not contributing to the heat exchanges.

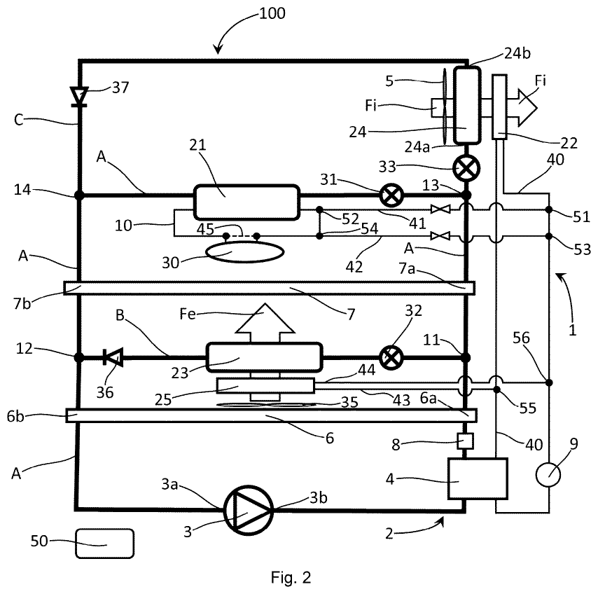

According to one variant of the first embodiment of the thermal conditioning system, illustrated in FIG. 2, the main loop A comprises a first internal exchanger 6 configured to allow a heat exchange between the high-pressure refrigerant downstream of the two-fluid exchanger 4 and upstream of the first junction point 11, and the low-pressure refrigerant downstream of the second junction point 12 and upstream of the compression device 3.

The first internal exchanger 6 comprises a first heat exchange section 6a positioned on the main loop A downstream of the two-fluid exchanger 4 and upstream of the first junction point 11. The first internal exchanger 6 comprises a second heat exchange section 6b positioned on the main loop A downstream of the second junction point 12 and upstream of the compression device 3. The first internal exchanger 6 is configured to allow a heat exchange between the refrigerant in the first heat exchange section 6a and the refrigerant in the second heat exchange section 6b.

According to the variant embodiment illustrated in FIG. 2, the main loop A comprises a second internal exchanger 7 configured to allow a heat exchange between the high-pressure refrigerant downstream of the first junction point 11 and upstream of the third junction point, and the low-pressure refrigerant downstream of the fourth junction point 14 and upstream of the second junction point 12.

The second internal exchanger 7 comprises a first heat exchange section 7a positioned on the main loop A downstream of the first junction point 11 and upstream of the third junction point 13. The second internal exchanger 7 comprises a second heat exchange section 7b positioned on the main loop A downstream of the fourth junction point 14 and upstream of the second junction point 12. The second internal exchanger 7 is configured to allow a heat exchange between the refrigerant in the first heat exchange section 7a and the refrigerant in the second heat exchange section 7b.

The first internal exchanger 6 and the second internal exchanger 7 make it possible to increase the heat exchanges and thus improve the performance of the thermal conditioning system 100.

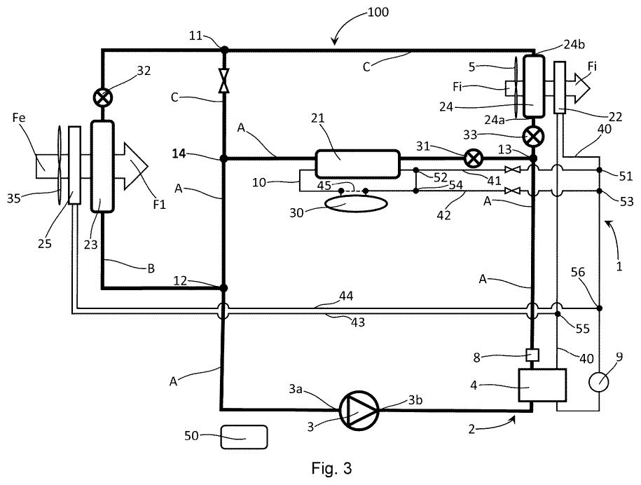

FIG. 3 illustrates a second embodiment of the thermal conditioning system 100. According to this second embodiment, the thermal conditioning system 100 comprises a refrigerant circuit 2 comprising:
a main loop A comprising in succession in the direction of travel of the refrigerant:
a compression device 3,
a two-fluid exchanger 4,
a first expansion device 31,
a first heat exchanger 21,
the two-fluid exchanger 4 and the first heat exchanger 21 being arranged both on the refrigerant circuit 2 and on the heat transfer liquid circuit 1 so as to allow a heat exchange between the refrigerant and the heat transfer liquid,
the first heat exchanger 21 being configured to be thermally coupled to an element 30 of an electric drive train of a motor vehicle,
a second bypass branch C connecting a third junction point 13 positioned on the main loop A downstream of the two-fluid exchanger 4 and upstream of the first expansion device 31 to a fourth junction point 14 positioned on the main loop A downstream of the first heat exchanger 21 and upstream of the compression device 3, the first bypass branch B comprising a third expansion device 33 and a fourth heat exchanger 24 configured to exchange heat with the inside air stream Fi,
a first bypass branch B connecting a first junction point 11 positioned on the second bypass branch C downstream of the fourth heat exchanger 24 and upstream of the fourth junction point 14 to a second junction point 12 positioned on the main loop A downstream of the fourth junction point 14 and upstream of the compression device 3, the first bypass branch B comprising a second expansion device 32 and a third heat exchanger 23 configured to exchange heat with an outside air stream Fe, the third heat exchanger 23 being configured to operate at least as an evaporator.

In other words, the second embodiment differs from the first embodiment in the arrangement of the bypass branches B and C relative to the main loop A.

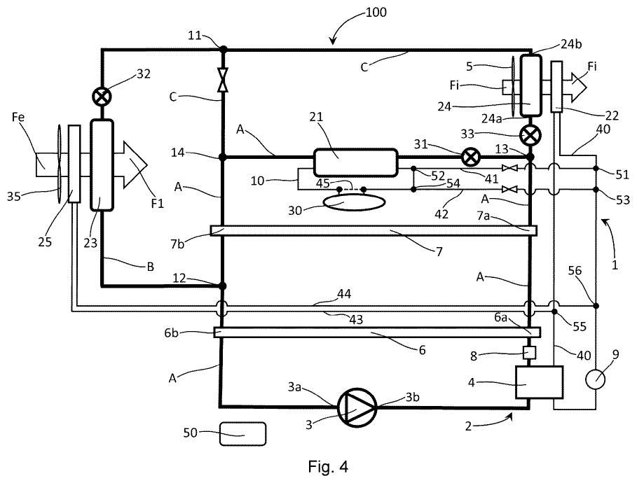

According to one variant embodiment, illustrated in FIG. 4, the main loop A comprises a first internal exchanger 6 positioned in the same way as in the variant of the first embodiment, illustrated in FIG. 2.

The refrigerant circuit 2 also comprises a second internal exchanger 7 configured to allow a heat exchange between the high-pressure refrigerant in the main loop A downstream of the first internal exchanger 6 and upstream of the third junction point 13, and the low-pressure refrigerant in the main loop A downstream of the fourth junction point 14 and upstream of the second junction point 12.

According to the second embodiment and its variant, the main loop A comprises a refrigerant accumulation device 8 positioned downstream of the two-fluid exchanger 4 and upstream of the third junction point 13.

According to the first embodiment and its variant, the main loop A comprises a refrigerant accumulation device 8 positioned downstream of the two-fluid exchanger 4 and upstream of the first junction point 11.

According to the variant of the first embodiment of the thermal conditioning system, illustrated in FIG. 2, the main loop A comprises a refrigerant accumulation device 8 positioned downstream of the two-fluid exchanger 4 and upstream of the first internal exchanger 6.

What is claimed is:

1. A method for controlling a thermal conditioning system for a motor vehicle, the thermal conditioning system including:
a heat transfer liquid circuit configured to circulate a heat transfer liquid,
a refrigerant circuit including in succession:
a compression device,
a two-fluid exchanger,
a first heat exchanger,
a first expansion device positioned upstream of the first heat exchanger, the two-fluid exchanger and the first heat exchanger being arranged both on the refrigerant circuit and on the heat transfer liquid circuit so as to allow a heat exchange between the refrigerant and the heat transfer liquid,
the heat transfer liquid circuit including a second heat exchanger configured to exchange heat with an air stream inside a passenger compartment of the motor vehicle,
the method comprising:
determining an ambient temperature outside the motor vehicle,
and if the ambient temperature is less than a first predetermined temperature threshold:
circulating refrigerant in succession in the compression device, in the two-fluid-exchanger, and then in the first heat exchanger,
circulating heat transfer liquid in the two-fluid exchanger, in the first heat exchanger, and in the second heat exchanger.

2. A method according to claim 1, in which during circulating refrigerant in succession in the compression device, in the two-fluid exchanger, and then in the first heat exchanger, a mass flow rate of refrigerant in the two-fluid exchanger is equal to a mass flow rate of refrigerant in the first heat exchanger.

3. A method according to claim 1, further comprising:
determining a temperature of the heat transfer liquid at the inlet of the second heat exchanger,
and if the temperature of the heat transfer liquid at the inlet of the second heat exchanger is less than or equal to a second predetermined temperature threshold,
maintaining a flow rate of the inside air stream below a first predetermined flow rate threshold.

4. A method according to claim 1, further comprising:
determining a temperature of the heat transfer liquid at the inlet of the second heat exchanger,
and if the temperature of the heat transfer liquid at the inlet of the second heat exchanger is less than or equal to the second predetermined temperature threshold, increasing a rotation speed of the compression device to a predetermined maximum value.

5. A method according to claim 3, further comprising:
determining a temperature of the heat transfer liquid at the inlet of the second heat exchanger,
and if the temperature of the heat transfer liquid at the inlet of the second heat exchanger is greater than the second predetermined temperature threshold,
generating a flow rate of the inside air stream greater than a second predetermined flow rate threshold.

6. A method according to claim 3, further comprising:
controlling a rotation speed of the compression device so as to regulate a temperature of the heat transfer liquid at the inlet of the second heat exchanger at a setpoint value if the temperature of the heat transfer liquid at the inlet of the second heat exchanger is greater than the second predetermined temperature threshold.

7. A method according to claim 6, further comprising:
receiving a setpoint value of the temperature of the heat transfer liquid at the inlet of the second heat exchanger,
determining a temperature of the heat transfer liquid at the inlet of the second heat exchanger,
determining a difference between the temperature of the heat transfer liquid determined at the inlet of the second heat exchanger and the setpoint value of the temperature of the heat transfer liquid at the inlet of the second heat exchanger, and if the difference determined difference is less than 0,
increasing a rotation speed of the compression device.

8. A method according to claim 7, further comprising:
reducing a rotation speed of the compression device if the determined difference is greater than 0 and less than a predetermined maximum value.

9. A method according to claim 7, further comprising:
deactivating the compression device if the determined difference is greater than 0 and greater than the predetermined maximum value.

10. A thermal conditioning system for a motor vehicle, the thermal conditioning system comprising:
a heat transfer liquid circuit configured to circulate a heat transfer liquid,
a refrigerant circuit including in succession:
a compression device,
a two-fluid exchanger,
a first heat exchanger,
a first expansion device positioned upstream of the first heat exchanger, the two-fluid exchanger and the first heat exchanger being arranged both on the refrigerant circuit and on the heat transfer liquid circuit so as to allow a heat exchange between the refrigerant and the heat transfer liquid,
the heat transfer liquid circuit comprising including a second heat exchanger configured to exchange heat with an air stream inside a passenger compartment of the motor vehicle,
an electronic control unit configured to implement a method including:
determining an ambient temperature outside the vehicle,
and if the ambient temperature is less than a first predetermined temperature threshold:
circulating refrigerant in succession in the compression device, in the two-fluid exchanger, and then in the first heat exchanger,
circulating heat transfer liquid in the two-fluid exchanger, in the first heat exchanger, and in the second heat exchanger.

11. The thermal conditioning system according to claim 10, in which the first heat exchanger is configured to be thermally coupled to an element of an electric drive train of a motor vehicle, the element of the electric drive train of the vehicle being configured to exchange heat with a heat transfer liquid circulating in an auxiliary heat transfer liquid loop and the first heat exchanger being configured to exchange heat with the heat transfer liquid circulating in the auxiliary heat transfer liquid loop.
